(19) United States
(12) Patent Application Publication
(10) Pub. No.: US 2024/0252980 A1
(43) Pub. Date: Aug. 1, 2024

(54) DIRECT AIR CAPTURE REACTOR SYSTEMS AND RELATED METHODS OF TRANSPORTING CARBON DIOXIDE

(71) Applicant: Battelle Energy Alliance, LLC, Idaho Falls, ID (US)

(72) Inventors: Dong Ding, Idaho Falls, ID (US); Lucun Wang, Idaho Falls, ID (US); Wei Wu, Idaho Falls, ID (US)

(21) Appl. No.: 18/560,909

(22) PCT Filed: May 18, 2022
(86) PCT No.: PCT/US2022/072394

§ 371 Date: Nov. 14, 2023

Related U.S. Application Data
(60) Provisional application No. 63/201,967, filed on May 20, 2021.

(51) Int. Cl. B01D 53/32; B01D 53/62; B01D 71/02

(52) U.S. Cl. CPC B01D 53/326; B01D 53/62; B01D 71/0271; B01D 2257/504

(57) ABSTRACT

A direct air capture (DAC) reactor system is disclosed and comprises electrochemical cells. One or more of the electrochemical cells comprises a cathode, an anode, and an electrolyte membrane between the cathode and the anode. The electrolyte membrane is configured to transport carbonate ions and oxygenate ions from the cathode to the anode. Additional DAC reactor systems and methods of capturing carbon dioxide from a feedstream using the reactor systems are also disclosed.

### CROSS REFERENCE TO RELATED APPLICATIONS

This application is a national phase entry under 35 U.S.C. § 371 of International Patent Application PCT/US2022/072394, filed May 18, 2022, designating the United States of America and published as International Patent Publication WO 2022/246415 A1 on Nov. 24, 2022, which claims the benefit under Article 8 of the Patent Cooperation Treaty to U.S. Patent Application Ser. No. 63/201,967, filed May 20, 2021.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure relate to systems and methods for transporting and capturing carbon dioxide. More specifically, embodiments of the disclosure relate to reactor systems for direct air capture and to methods of transporting and capturing carbon dioxide using the reactor systems.

### BACKGROUND

As global energy demand has increased, combustion of fossil fuels has, as well. As a result, unprecedented amounts of carbon dioxide (CO₂) have been released into the atmosphere, and carbon dioxide emissions rate continues to escalate. Concern regarding the potential negative consequences (e.g., climate change effects) of these increasing emissions has driven efforts to reduce atmospheric carbon dioxide levels through carbon dioxide capture, sequestration, and/or utilization. In addition to reducing carbon dioxide emissions, direct capture of carbon dioxide from ambient air (e.g., direct air capture (DAC)) has been investigated to lower the atmospheric carbon dioxide concentration. Conventional methods for the direct capture of carbon dioxide include using solid sorbents or aqueous solutions as a capture media. However, regenerating the sorbent utilizes high energy input, which increases operating costs. Membrane technology, such as chemical potential driven permeation cells, has been investigated as a more energy-efficient alternative. Permeable membrane-based processes offer in situ carbon dioxide sequestration and have a relatively long service time with no regeneration procedure needed. These DAC processes are effective to remove carbon dioxide from some feedstreams including a relatively high concentration of carbon dioxide.

### BRIEF SUMMARY

A direct air capture reactor system is disclosed and comprises electrochemical cells. One or more of the electrochemical cells comprises a cathode, an anode, and an electrolyte membrane between the cathode and the anode. The electrolyte membrane is configured to transport carbonate ions and oxygenate ions from the cathode to the anode.

Another direct air capture reactor system is disclosed and comprises one or more electrochemical cells between a first chamber and a second chamber. The one or more electrochemical cells comprise a cathode, an anode, and an electrolyte membrane between the cathode and the anode. The electrolyte membrane is configured to transport carbonate ions and oxygenate ions across the electrolyte membrane from the first chamber to the second chamber.

A method of capturing carbon dioxide from a feedstream is disclosed and comprises introducing a carbon dioxide-containing feedstream to an electrochemical cell. The carbon dioxide-containing feedstream comprises less than about 1000 ppm of carbon dioxide. The electrochemical cell comprises a cathode, an electrolyte membrane adjacent to the cathode, and an anode adjacent to the electrolyte membrane. The carbon dioxide of the carbon dioxide-containing feedstream is reacted at the cathode to produce carbonate ions. The carbonate ions are transported through the electrolyte membrane and to the anode. The carbonate ions are reacted at the anode to produce carbon dioxide, which is recovered as a concentrated carbon dioxide feedstream.

### BRIEF DESCRIPTION OF THE DRAWINGS

FIG. 1 is an electrochemical cell according to embodiments of the disclosure;

FIG. 2 is a direct air capture (DAC) reactor system according to embodiments of the disclosure; and

FIG. 3 is a DAC reactor system according to other embodiments of the disclosure.

### DETAILED DESCRIPTION

A reactor system for direct capture of carbon dioxide (CO₂) from a feedstream (e.g., an initial feedstream, a carbon dioxide-containing feedstream) is disclosed. The reactor system may be a solid oxide membrane reactor system, such as a solid oxide carbon dioxide permeation membrane system driven by a chemical gradient of carbon dioxide, or may be an electrochemical carbon dioxide pump system driven by an externally applied, electrochemical potential. The reactor system may be operated at a temperature of between about 400° C. and about 650° C. The carbon dioxide-containing feedstream is passed through the reactor system and the carbon dioxide is removed and sequestered (e.g., captured). The sequestered carbon dioxide may be recovered and stored, or may be recovered, collected, and used as a feedstock in various industrial processes. Other components of the initial feedstream may also be recovered, collected, and used as a feedstock in various industrial processes. The reactor system may enable the direct air capture (DAC) of carbon dioxide from the initial feedstream that includes carbon dioxide at a low amount (e.g., a low concentration), such as from an air feedstream (e.g., ambient air). However, the reactor system may also be used for the DAC of carbon dioxide from a feedstream that includes a higher amount or concentration of carbon dioxide. The DAC reactor system may be driven by, for example, an electrical power source, a gradient of carbon dioxide, or a carbon dioxide pump.

In the DAC reactor system, the carbon dioxide from the carbon dioxide-containing feedstream is selectively sorbed (e.g., absorbed, adsorbed), converted to ions, transported through the DAC reactor system, recovered, and collected to produce a concentrated carbon dioxide source (e.g., a concentrated carbon dioxide stream, recovered carbon dioxide). The concentrated carbon dioxide stream includes a greater amount or concentration of carbon dioxide compared to the carbon dioxide-containing feedstream. The carbon dioxide is recovered from the DAC reactor system according to embodiments of the disclosure at a high purity. The carbon dioxide is removed from the carbon dioxide-containing feedstream in a short amount of time using the DAC reactor system according to embodiments of the disclosure.

In addition to the concentrated carbon dioxide stream, the DAC reactor system may produce a carbon dioxide-depleted stream that includes additional components, such as oxygen (O₂), from the initial feedstream. The carbon dioxide-depleted feedstream may include a relatively lower concentration of carbon dioxide compared to the carbon dioxide-containing feedstream and a relative higher concentration of oxygen than the carbon dioxide-containing feedstream. The carbon dioxide-depleted stream may also include gaseous components in addition to oxygen. Depending on the components in the initial stream, the carbon dioxide-depleted stream or further purified components of the carbon dioxide-depleted stream may be commercially valuable and used as a feedstock in various industrial processes.

The DAC reactor system according to embodiments of the disclosure enables cost-effective, energy-efficient, and highly selective in situ capture of the carbon dioxide from the initial feedstream (e.g., the carbon dioxide-containing feedstream) that may contain a relatively low carbon dioxide concentration. The carbon dioxide may be quickly and efficiently removed from the carbon dioxide-containing feedstream under a variety of conditions, such as under different process conditions (e.g., operational conditions). For example, the DAC reactor system according to embodiments of the disclosure may be used to remove the carbon dioxide from different (e.g., variable) compositions of the carbon dioxide-containing feedstream, different (e.g., variable) humidity levels of the carbon dioxide-containing feedstream, or different (e.g., variable) temperatures of the carbon dioxide-containing feedstream. By utilizing chemical and physical properties of carbon dioxide, the carbon dioxide is absorbed (e.g., selectively absorbed) from the carbon dioxide-containing feedstream in a cathode of the DAC reactor system, electrons are transferred to the carbon dioxide to form ions, the ions are transported (e.g., migrate, diffuse) through an electrolyte membrane of the DAC reactor system to an anode, and the ions are desorbed, releasing the carbon dioxide from the DAC reactor system. The carbon dioxide is, therefore, able to be recovered and collected from the carbon dioxide-containing feedstream that contains a low amount or a low concentration of the carbon dioxide. In contrast, conventional DAC systems and processes are not effective or time efficient to remove carbon dioxide from feedstreams that include a low amount or a low concentration of carbon dioxide.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those system components and acts necessary to understand the embodiments of the disclosure are described in detail below. A person of ordinary skill in the art will understand that some system components (e.g., pipelines, line filters, valves, temperature detectors, flow detectors, pressure detectors, and the like) are inherently disclosed herein and that adding various conventional system components and acts would be in accord with the disclosure. In addition, the drawings accompanying the application are for illustrative purposes only, and are not meant to be actual views of any particular material, device, or system.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, and arrangement of one or more of at least one structure and at least one system facilitating operation of one or more of the structure and the system in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “electrode” means and includes an electrode having a relatively lower electrode potential in an electrochemical cell (i.e., lower than the electrode potential in a positive electrode therein) or an electrode having a relatively higher electrode potential in an electrochemical cell (i.e., higher than the electrode potential in a negative electrode therein).

As used herein the term “electrolyte” means and includes an ionic conductor, which can be in a solid state, a liquid state, or a gas state (e.g., plasma).

As used herein, the term “compatible” means that a material does not undesirably react, decompose, or absorb another material, and also that the material does not undesirably impair the chemical and/or mechanical properties of the another material.

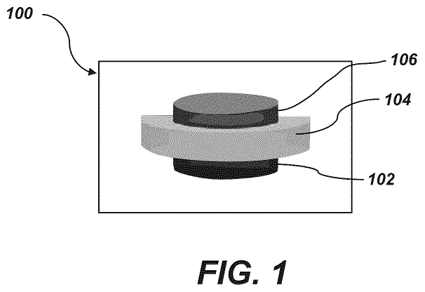

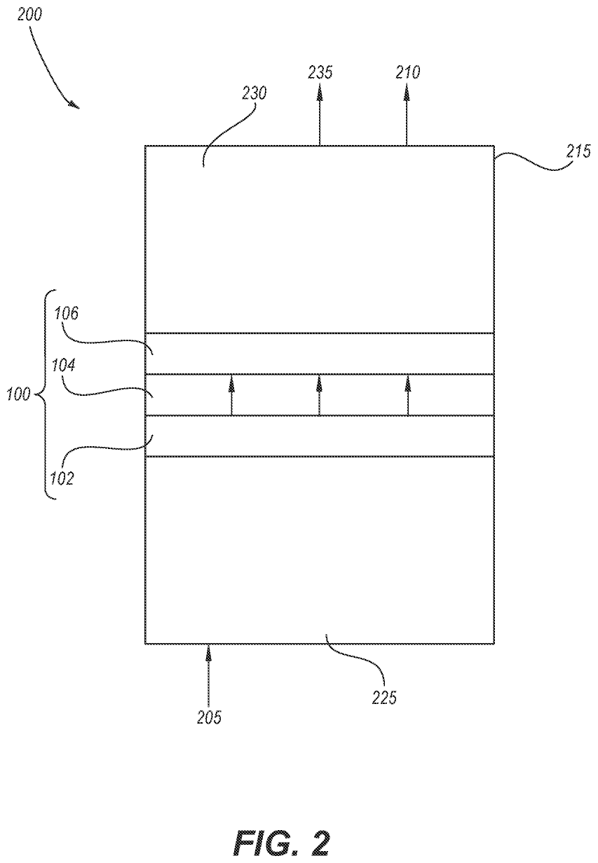

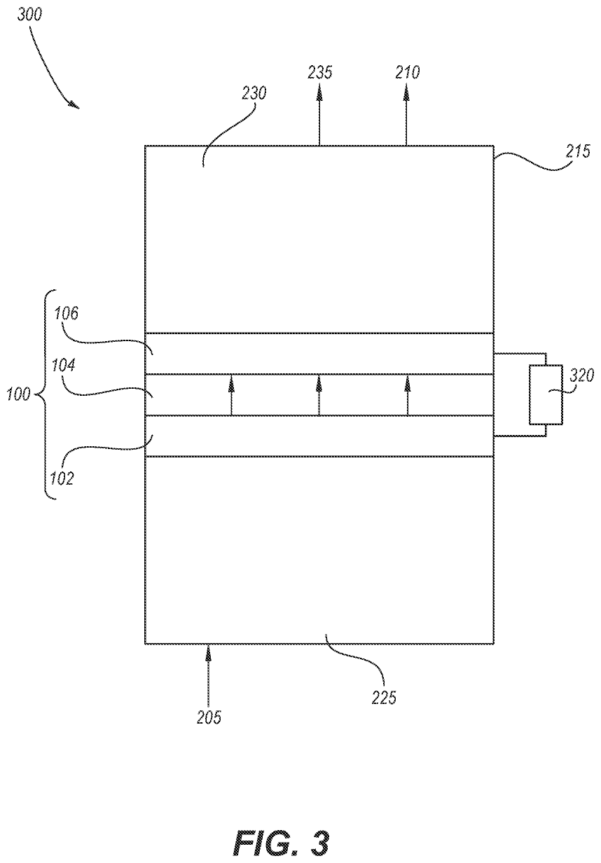

An electrochemical cell 100 that includes a positive electrode (e.g., a cathode 102), a membrane (e.g., an electrolyte membrane 104), and a negative electrode (e.g., an anode 106) is shown in FIG. 1. In the electrochemical cell 100, the electrolyte membrane 104 is positioned between the cathode 102 and the anode 106. The electrolyte membrane 104 may be adhered to or otherwise secured between the cathode 102 and the anode 106. The electrochemical cell 100 is configured to transport carbon dioxide across the electrolyte membrane 104. One or more electrochemical cells 100 may be present in a DAC reactor system 200, 300 (see FIGS. 2 and 3). For simplicity and convenience, FIGS. 2 and 3 illustrate one (e.g., a single) electrochemical cell 100 in the DAC reactor system 200, 300. However, multiple electrochemical cells 100 may be present, with the electrochemical cells 100 coupled together or operatively associated. The electrolyte membrane 104 functions as a carrier of carbon dioxide by converting the carbon dioxide of the carbon dioxide-containing feedstream to carbonate ions (CO₃²⁻) and electrons (e⁻) at the cathode 102, transporting the carbonate ions through the electrolyte membrane 104, and reacting the carbonate ions with oxygen (O₂) and electrons at the anode 106 to form the carbon dioxide (e.g., the concentrated carbon dioxide stream).

The cathode 102, the anode 106, and the electrolyte membrane 104 may be formed from conventional materials and are of conventional configurations to achieve the carbon dioxide transport and capture. The cathode 102, the anode 106, and the electrolyte membrane 104 may, for example, be configured as a powder or as pellets. The cathode 102, the anode 106, and the electrolyte membrane 104 may be produced by conventional techniques including, but not limited to, a rolling process, milling process, shaping process, pressing process, consolidation process, etc., which are not described in detail herein. The materials of the cathode 102, the anode 106, and the electrolyte membrane 104 may be compatible with operational conditions (e.g., temperature conditions, pressure conditions, voltage conditions) that are present during use and operation of the DAC reactor system 200, 300. In other words, materials of the cathode 102, the anode 106, and the electrolyte membrane 104 are not decomposed, damaged, or otherwise deteriorated when exposed to the process conditions within the DAC reactor system 200, 300.

The material of the cathode 102 may, for example, be a perovskite-based material including, but not limited to, a double perovskite material, such as MBa₁₋ₓSrₓCo_{2-y}Fe_{y}O_{5αδ}, wherein x and y are dopant levels, δ is the oxygen deficit, and M is Pr, Nd, or Sm (e.g., PrBa_{0.5}Sr_{0.5}Co_{1.5}Fe_{0.5}O_{5+δ} (PBSCF), NdBa_{0.5}Sr_{0.5}Co_{1.5}Fe_{0.5}O_{5+δ}, SmBa_{0.5}Sr_{0.5}Co_{1.5}Fe_{0.5}O_{5+δ}); a single perovskite material, such as Sm₁₋ₓSrₓCoO_{3-δ} (SSC), BaZr_{1-x-y-z}CoₓFe_{y}Y_{z}O_{3-δ}, or SrScₓNd_{y}Co_{1-x-y}O_{3-δ}, wherein x, y, and z are dopant levels and δ is the oxygen deficit; a Ruddleson-Popper-type perovskite material, such as M₂NiO_{4-δ}, wherein δ is the oxygen deficit and M is La, Pr, Gd, or Sm (e.g., La₂NiO_{4-δ}, Pr₂NiO_{4-δ}, Gd₂NiO_{4-δ}, Sm₂NiO_{4-δ}); a single perovskite/perovskite composite material such as SSC—BZCYYb, or a cermet material comprising at least one metal (e.g., Ni) and at least one perovskite, such as a nickel/perovskite cermet (Ni-perovskite) material (e.g., Ni—BZCYYb, NiO—BZCYYb, Ni—BSNYYb, Ni—BaCeO₃, Ni—BaZrO₃, Ni—Ba₂(YSn)O_{5.5}, Ni—Ba₃(CaNb₂)O₉). In some embodiments, the cathode 102 is an SSC material. The material of the anode 106 may be one of the materials described above for the cathode 102. In some embodiments, the material composition of the anode 106 is the same as the material composition of the cathode 102. In other embodiments, the anode 106 and cathode 102 are formed from and include different material compositions.

The electrolyte membrane 104 may be configured and formulated to be at least semipermeable to carbon dioxide. The electrolyte membrane 104 functions as an ion conducting phase to transport the carbonate ions between the cathode 102 and the anode 106 of the DAC reactor system 200, 300. The electrolyte membrane 104 may be configured and formulated to exhibit sufficient oxide and carbonate ion conductivities to separate (e.g., dissociate) the carbon dioxide. The electrolyte membrane 104 is, for example, configured and formulated to transport the carbonate ions between the cathode 102 and the anode 106. The electrolyte membrane 104 may also be configured and formulated to exhibit a high selectivity and flux density for carbon dioxide. The electrolyte membrane 104 may be formed of and include a material formulated to exhibit an ionic conductivity between about 0.01 S/cm and about 0.1 S/cm at a temperature within a range of from about 400° C. to about 650° C.

The electrolyte membrane 104 may be an oxide-carbonate composite electrolyte membrane, such as a ceria-based oxide ion conductor membrane. For example, the oxide-carbonate composite electrolyte membrane may be a ceria-based oxide ion conductor membrane or a cubic fluorite oxide ion conductor membrane (yttrium-stabilized zirconia (YSZ)) for the oxide phase, and a eutectic mixture of alkaline carbonates for the carbonate phase. The material of the electrolyte membrane 104 may include, but is not limited to, a perovskite material compatible with an operational temperature (e.g., a temperature at which the ion conductivity is between about 0.01 S/cm and about 0.1 S/cm) of from about 400° C. to about 650° C., such as from about 500° C. to about 600° C. By way of non-limiting example, the perovskite material may be one or more of a yttrium- and ytterbium-doped barium-zirconate-cerate (BZCYYb) material, such as BaZr_{0.8-y}Ce_{y}Y_{0.2-x}YbₓO_{3-δ}, wherein x and y are dopant levels and S is the oxygen deficit (e.g., BaZr_{0.3}Ce_{0.5}Y_{0.1}Yb_{0.1}O_{3-δ}), gadolinium-doped ceria (GDC), or doped barium-cerate (BaCeO—₃)(e.g., yttrium-doped BaCeO₃ (BCY)). In some embodiments, the oxide-carbonate composite electrolyte membrane is a BZCYYb material. In some embodiments, the oxide-carbonate composite electrolyte membrane is a GDC/(Li,K)₂CO₃ composite. The carbonate phase and the oxide phase may be distributed in a core-shell structure where grains of crystalline oxides are covered by a layer of amorphous carbonate phase. By appropriately selecting the material of the electrolyte membrane 104, selective carbon dioxide capture from ambient air may be achieved and a high purity, concentrated carbon dioxide stream produced.

The DAC reactor system 200, 300 may be configured as a carbon dioxide permeable membrane based reactor system or as an electrochemical carbon dioxide pump based reactor system. As shown in FIGS. 2 and 3, the DAC reactor system 200, 300 includes a housing structure 215 that contains the one or more electrochemical cells 100 and an optional power source 320 (see FIG. 3). The housing structure 215 and the power source 320, when present, are conventional and, therefore, are not described in detail herein. Depending on a desired location for installing and using the DAC reactor system 200, 300, the power source 320 may be present (see FIG. 3) and is electrically connected (e.g., coupled) to the one or more electrochemical cells 100. In such embodiments, external power to the DAC reactor system 300 may be supplied by the power source 320. In other embodiments, no power source is present (see FIG. 2) and the DAC reactor system 200 may be used in locations were no electrical power is available or where electrical power is not reliably available. In such embodiments, the DAC reactor system 200 may be driven by chemical gradients (e.g., carbon dioxide gradients) or electrochemical potential. During use and operation of the DAC reactor system 200, 300, electricity is generated in some embodiments, while no electricity is generated in other embodiments. Some embodiments may utilize electricity in order to capture the carbon dioxide, while no electricity may be utilized to capture the carbon dioxide in other embodiments.

The DAC reactor system 200, 300 includes a first chamber 225 adjacent to the cathode 102 and a second chamber 230 adjacent to the anode 106. The first chamber 225 and the second chamber 230 of the DAC reactor system 200, 300 are fluidly connected with one another such that a carbon dioxide-containing feedstream 205 may be transported through the first chamber 225, the electrochemical cell 100, and into the second chamber 230 of the DAC reactor system 200, 300. The carbon dioxide-containing feedstream 205 is introduced to the first chamber 225 through an inlet (not shown), passes through the one or more electrochemical cells 100, and a concentrated carbon dioxide stream 210 exits the second chamber 230 through an outlet (not shown). In addition to carbon dioxide, the carbon dioxide-containing feedstream 205 may include other components, such as other gaseous components. The carbon dioxide-containing feedstream 205 may be an air feedstream (e.g., an atmospheric air feedstream, an ambient air feedstream), which includes nitrogen (N₂), oxygen, carbon dioxide, and other gases, with the nitrogen and oxygen being present at a relatively greater amount relative to the carbon dioxide and the other components. In some embodiments, the carbon dioxide-containing feedstream 205 is an air feedstream and the carbon dioxide may be present at about 0.04% by volume. The air feedstream may also include water, such as from about 0.1% by volume to about 5.0% by volume of water. However, the air feedstream may include a relatively higher or relatively lower amount of carbon dioxide or of water depending on the source of the air feedstream. For instance, atmospheric air from a more humid location on Earth may include a relatively higher amount of water than atmospheric air from a drier location on Earth. The DAC reactor system 200, 300 according to embodiments of the disclosure may be used to sequester carbon dioxide from the air feedstream including variable amounts of nitrogen, oxygen, carbon dioxide, water, and other gaseous components. The DAC reactor system 200, 300 may, therefore, be used to sequester carbon dioxide from air feedstreams having variable compositions.

The DAC reactor system 200, 300 may optionally include at least one heating apparatus (not shown) operatively associated with the electrochemical cells 100. The DAC reactor system 200, 300 may optionally include one or more apparatuses (e.g., heat exchangers, pumps, compressors, expanders, mass flow control devices, etc.) operatively associated with the electrochemical cells 100 to adjust one or more of temperature, pressure, and flow rate of the carbon dioxide-containing feedstream 205 and the concentrated carbon dioxide stream 210.

The DAC reactor system 200 of FIG. 2 may be configured as a solid oxide carbon dioxide permeation membrane system and is driven by a chemical gradient of carbon dioxide. No electricity is utilized during use and operation of the solid oxide carbon dioxide permeation membrane system of FIG. 2. In FIG. 3, the DAC reactor system 300 may be configured as an electrochemical carbon dioxide pump system driven by an externally applied, electrochemical potential. Electricity is utilized during use and operation of the electrochemical carbon dioxide pump system of FIG. 3.

During use and operation of the DAC reactor system 200, 300, carbon dioxide is removed (e.g., captured) from the carbon dioxide-containing feedstream 205. The carbon dioxide-containing feedstream 205 is introduced into the DAC reactor system 200, 300 and contacts the cathode 102. Upon contact, the carbon dioxide may be adsorbed onto the cathode 102, reacted with oxygen of the carbon dioxide-containing feedstream 205, and converted to the carbonate ions. During the reaction, electrons are transferred to the carbon dioxide, forming the carbonate ions and oxygenate ions. A transport rate of the carbonate ions through the electrolyte membrane 104 and into the anode 106 may be controlled by appropriately selecting the composition of the electrolyte membrane 104 and process conditions (e.g., reaction temperature, reaction pressure) under which the reaction occurs. By increasing the reaction temperature, the transport rate of the carbonate ions through the electrolyte membrane 104 may be increased. The carbonate ions may be dissolved into the electrolyte membrane 104 and migrate through (indicated by arrows in FIGS. 2 and 3) the electrolyte membrane 104 to the anode 106. The carbonate ions react with oxygenate ions (O₂) at the anode 106 to produce carbon dioxide, which is removed (e.g., released) from the anode 106.

The carbon dioxide is recovered from the second chamber 230 as the concentrated carbon dioxide stream 210. A carbon dioxide-depleted stream 235 may also be recovered. The concentrated carbon dioxide stream 210 exiting from the DAC reactor system 200, 300 may have an increased concentration of carbon dioxide relative to the concentration of carbon dioxide in the carbon dioxide-containing feedstream 205. The concentrated carbon dioxide stream 210 may also be of a high purity. By way of example only, the concentrated carbon dioxide stream 210 may have a purity of greater than about 90% by volume, such as greater than about 95% by volume or greater than about 99% by volume. The concentrated carbon dioxide stream 210 may be collected for use as a starting material or as a commodity chemical. The concentrated carbon dioxide stream 210 may, for example, be used in various industries, such as in oil recovery, chemical production/manufacturing, or coal-fired power plants. Since the concentrated carbon dioxide stream 210 may be produced at a low cost, the recovered carbon dioxide may be used in various industrial processes that are currently too expensive to conduct using the carbon dioxide recovered from conventional DAC processes. For example, the concentrated carbon dioxide stream 210 may be used to enhance oil recovery by carbon dioxide injection, production of carbon-neutral synthetic fuel and plastics, food/beverage carbonation, or agriculture, such as enhancing productivity of algae farms. The carbon dioxide-depleted stream 235, if present, may also be collected for use as a starting material or as a commodity chemical.

The carbon dioxide-containing feedstream 205 introduced to the first chamber 225 of the DAC reactor system 200, 300 may be a dilute carbon dioxide-containing feedstream that contains less than about 1000 parts per million (ppm) of the carbon dioxide. The carbon dioxide-containing feedstream 205 may include from about 200 ppm to about 1000 ppm carbon dioxide, such as from about 300 ppm to about 900 ppm carbon dioxide, from about 300 ppm to about 800 ppm carbon dioxide, from about 300 ppm to about 700 ppm carbon dioxide, from about 350 ppm to about 700 ppm carbon dioxide, from about 350 ppm to about 600 ppm carbon dioxide, from about 350 ppm to about 500 ppm carbon dioxide, or from about 375 ppm to about 425 ppm carbon dioxide. In some embodiments, the carbon dioxide is present in the carbon dioxide-containing feedstream 205 at about 400 ppm.

In addition to carbon dioxide, the carbon dioxide-containing feedstream 205 may include other components, such as other gaseous components. The carbon dioxide-containing feedstream 205 may be an air feedstream (e.g., an atmospheric air feedstream, an ambient air feedstream), which includes the carbon dioxide, nitrogen, oxygen, and other gases, with the nitrogen and oxygen being present at a relatively greater amount relative to the carbon dioxide and the other components. For example, the carbon dioxide may be present in the air feedstream at about 0.04% by volume. The carbon dioxide-containing feedstream 205 may also include water, such as at from about 0.1% by volume to about 5.0% by volume of water. However, the carbon dioxide-containing feedstream 205 may include a relatively higher or relatively lower amount of carbon dioxide or of water depending on the source of the air feedstream. The air feedstream may, therefore, have a variable composition. For instance, the air feedstream from a more humid location on Earth may include a relatively higher amount of water than the air feedstream from a drier location on Earth. In some embodiments, the carbon dioxide-containing feedstream 205 is atmospheric air. While the carbon dioxide-containing feedstream 205 may be an air feedstream, the carbon dioxide-containing feedstream 205 may be a more concentrated carbon dioxide-containing feedstream, such as containing carbon dioxide at greater than or equal to about 1000 ppm. By way of example only, the carbon dioxide-containing feedstream 205 may include the carbon dioxide at greater than about 10% by volume. For example, the carbon dioxide-containing feedstream 205 may be a carbon dioxide-containing feedstream from a coal fired power plant or from an ethanol fermenter.

The DAC reactor system 200, 300 according to embodiments of the disclosure may be used to sequester carbon dioxide from the air feedstream including variable amounts of nitrogen, oxygen, carbon dioxide, water, and other gaseous components, where the carbon dioxide may be present at a low concentration (less than about 1000 ppm) or at a relatively higher concentration (greater than or equal to about 1000 ppm). In contrast, conventional DAC processes and conventional reactor systems are limited to removing carbon dioxide from feedstreams having a higher concentration of carbon dioxide. The conventional DAC processes and the conventional reactor systems are not able to efficiently and quickly remove carbon dioxide from air since the carbon dioxide is present at a low amount. The conventional DAC processes and the conventional reactor systems are also limited to removing carbon dioxide from feedstreams having a specific (e.g., particular, known) composition. However, the DAC reactor system 200, 300 according to embodiments of the disclosure may be used to effectively remove carbon dioxide from carbon dioxide-containing feedstreams 205 having different (e.g., variable) compositions, such as air feedstreams having variable amounts of carbon dioxide or variable amounts of water. The DAC reactor system 200, 300 may, for example, be used to sequester carbon dioxide from atmospheric air having a low humidity (e.g., low water content) or a high humidity (e.g., high water content), or from atmospheric air having a variable amount of carbon dioxide. The relatively greater amount of oxygen in atmospheric air may impact surface oxidation states of the electrolyte membrane 104, especially at a high temperature, such as between about 400° C. and about 600° C. While embodiments herein describe the carbon dioxide-containing feedstream 205 as the air feedstream, the processes according to embodiments of the disclosure may be used to remove carbon dioxide from other carbon dioxide-containing feedstreams 205.

During use and operation of the DAC reactor system 200, the carbon dioxide-containing feedstream 205 is introduced to the first chamber 225, and carbon dioxide and oxygen from the carbon dioxide-containing feedstream 205 are dissociated at the cathode 102, as shown in FIG. 2. A flow rate of the carbon dioxide-containing feedstream 205 may be adjusted depending on the chemical compositions of the carbon dioxide-containing feedstream 205 and the electrolyte membrane 104. The flow rates may range from about 20 ml min⁻¹ to about 150 ml min⁻¹. The carbon dioxide and oxygen from the carbon dioxide-containing feedstream 205 are adsorbed onto the cathode 102 and converted to the carbonate ions and the oxygenate ions. The carbon dioxide, oxygen, and electrons react at the cathode 102 according to the following reaction:

CO₂+½O₂+2e⁻→CO₃²⁻ (Reaction 1).

The carbonate ions and oxygenate ions may dissolve into the electrolyte membrane 104 and migrate (e.g., diffuse) through the electrolyte membrane 104 to the anode 106, where the carbonate ions react with the oxygenate ions to produce carbon dioxide, oxygen, and electrons according to the following reaction:

CO₃²⁻→½O₂+CO₂+2e⁻ (Reaction 2).

The reactions at the cathode 102 and the anode 106 may be conducted at an elevated temperature to provide an effective transport rate of the carbonate ions through the electrolyte membrane 104. The carbon dioxide, oxygen, and electrons may be reacted at the cathode 102 and the anode 106 at a temperature within a range of from about 400° C. to about 650° C., such as from about 400° C. to about 600° C., from about 400° C. to about 550° C., from about 400° C. to about 500° C., from about 400° C. to about 450° C., from about 450° C. to about 600° C., from about 450° C. to about 550° C., from about 450° C. to about 500° C., from about 500° C. to about 600° C., from about 500° C. to about 550° C., from about 550° C. to about 650° C., from about 550° C. to about 600° C., or from about 600° C. to about 650° C. By way of example only, the DAC reactor system 200, 300 may be operated at a temperature of from about 400° C. to about 650° C., maintaining the carbon dioxide-containing feedstream 205 at a temperature within one of the ranges above.

The resulting concentrated carbon dioxide stream 210 and carbon dioxide-depleted stream 235 (e.g., oxygen) are removed (e.g., released) from the anode 106, and passed into the second chamber 230 before exiting the DAC reactor system 200. The concentrated carbon dioxide stream 210 and the carbon dioxide-depleted stream 235 exit the DAC reactor system 200 (e.g., the solid oxide carbon dioxide permeation membrane system) as one or more gaseous streams. While the carbon dioxide-depleted stream 235 may be oxygen, the carbon dioxide-depleted stream may include gaseous components in addition to oxygen. While FIG. 2 illustrates the concentrated carbon dioxide stream 210 and the carbon dioxide-depleted stream 235 as separate streams, the concentrated carbon dioxide stream 210 and the carbon dioxide-depleted stream 235 may be combined and exit the second chamber 230 as a single stream.

The carbon dioxide-containing feedstream 205 in the DAC reactor system 200 may be maintained at one or more temperatures within the above ranges during the DAC process. For instance, the carbon dioxide-containing feedstream 205 may be maintained at a first temperature in the first chamber 225, at a second temperature in the cathode 102, at a third temperature in the electrolyte membrane 104, at a fourth temperature in the anode 106, and at a fifth temperature in the second chamber 230. One or more of the first through fifth temperatures may be the same as one another or different from one another.

In the solid oxide carbon dioxide permeation membrane system of FIG. 2, the carbonate ions drive the chemical potential, with the gradient of carbon dioxide being present on both sides of the electrolyte membrane 104. No electricity is utilized during use and operation of the solid oxide carbon dioxide permeation membrane system. Therefore, the DAC reactor system 200 may be operated without adding energy.

In FIG. 3, the DAC reactor system 300 is configured as an electrochemical carbon dioxide pump system driven by an externally applied, electrochemical potential. The reactions at the cathode 102 and the anode 106 may be conducted by applying an electric potential power from the power source 320. A voltage of from about 0.7 V to about 1.0 V may be applied. Electricity is utilized during use and operation of the electrochemical carbon dioxide pump system. Similar to the process described above for the DAC reactor system 200, the carbon dioxide-containing feedstream 205 is introduced to the first chamber 225, and the carbon dioxide, oxygen, and electrons react at the cathode 102, according to Reaction 1, to form the carbonate ions, which migrate through the electrolyte membrane 104. Applying a bias to both sides of the electrolyte membrane 104 causes the carbonate ions to move from one side of the electrolyte membrane 104 to the other side. The transport of the carbonate ions through the electrolyte membrane 104 may depend on surface electron density and oxygen vacancy density properties of the electrolyte membrane 104. Interfaces in the electrolyte membrane 104 may also affect the transport of the carbonate ions through the electrolyte membrane 104. By way of example only, if an oxide-carbonate electrolyte membrane is used, the transport of the carbonate ions may be affected by tailoring the chemistry and electronic properties of the oxide phase of the electrolyte membrane 104. The carbonate ions are reacted, according to Reaction 2, at the anode 106, to form the carbon dioxide, oxygen, and electrons. The carbon dioxide and oxygen are then released from the anode 106 and exit the DAC reactor system 300 (e.g., the electrochemical carbon dioxide pump system) as the concentrated carbon dioxide stream 210 and the carbon dioxide-depleted stream 235 as gaseous streams. While FIG. 3 illustrates the concentrated carbon dioxide stream 210 and the carbon dioxide-depleted stream 235 as separate streams, the concentrated carbon dioxide stream 210 and the carbon dioxide-depleted stream 235 may be combined and exit the second chamber 230 as a single stream. During use and operation of the DAC reactor system 300, a potential difference (e.g., voltage) is applied between the cathode 102 and the anode 106 of the electrochemical cell 100 from the power source 320 so that the carbon dioxide interacts with the cathode 102, releasing electrons to generate the carbonate ions, which migrate through the electrolyte membrane 104 to the anode 106. The electrons are directed to the power source 320 through external circuitry, and the concentrated carbon dioxide stream 210 and the carbon dioxide-depleted stream 235 exit the DAC reactor system 300. While FIG. 3 illustrates the concentrated carbon dioxide stream 210 and the carbon dioxide-depleted stream 235 as separate streams, the concentrated carbon dioxide stream 210 and the carbon dioxide-depleted stream 235 may be combined and exit the second chamber 230 as a single stream.

The DAC reactor system 200, 300 and processes according to embodiments of the disclosure may be used to reduce levels of carbon dioxide in the atmosphere to slow global climate change. In addition to lowering atmospheric carbon dioxide, the DAC reactor system 200,300 and processes according to embodiments of the disclosure may be used to reduce carbon dioxide levels at specific locations, such as in areas proximal to industrial plants that are known to produce large amounts of carbon dioxide. By way of example only, the DAC reactor system 200, 300 and processes according to embodiments of the disclosure may be used around power plants where large amounts of carbon dioxide are produced. The electrochemical cells 100 used to capture the carbon dioxide are small, enabling the DAC reactor system 200, 300 to be produced in portable configurations. The DAC reactor system 200, 300 according to embodiments of the disclosure may, therefore, be highly portable and readily movable to locations where large amounts of carbon dioxide are produced. Therefore, carbon management may be conducted in a distributed, stationary, or mobile manner.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

1. A direct air capture reactor system, comprising:
electrochemical cells, one or more of the electrochemical cells comprising:
a cathode;
an anode; and
an electrolyte membrane between the cathode and the anode, the electrolyte membrane configured to transport carbonate ions and oxygenate ions from the cathode to the anode.

2. The direct air capture reactor system of claim 1, wherein the cathode comprises a material formulated to convert carbon dioxide to carbonate ions.

3. The direct air capture reactor system of claim 2, wherein the electrolyte membrane comprises a material formulated to transport the carbonate ions.

4. The direct air capture reactor system of claim 2, wherein the anode comprises a material formulated to convert the carbonate ions to carbon dioxide.

5. The direct air capture reactor system of claim 2, wherein the cathode comprises a material formulated to convert the carbon dioxide to the carbonate ions and to convert oxygen to oxygenate ions.

6. The direct air capture reactor system of claim 1, wherein the electrolyte membrane comprises an oxide-carbonate composite electrolyte membrane.

7. The direct air capture reactor system of claim 1, further comprising a power source operatively coupled to the one or more electrochemical cells.

8. A direct air capture reactor system, comprising:
one or more electrochemical cells between a first chamber and a second chamber, the one or more electrochemical cells comprising:
a cathode, an anode, and an electrolyte membrane between the cathode and the anode, the electrolyte membrane configured to transport carbonate ions and oxygenate ions across the electrolyte membrane from the first chamber to the second chamber.

9. The direct air capture reactor system of claim 8, wherein the electrolyte membrane is configured to produce a chemical gradient of carbon dioxide.

10. The direct air capture reactor system of claim 8, wherein the electrolyte membrane is configured to produce a gradient of carbon dioxide on both sides of the electrolyte membrane.

11. The direct air capture reactor system of claim 8, further comprising a power source configured to apply an electrochemical potential between the cathode and the anode.

12. A method of capturing carbon dioxide from a feedstream, comprising:
introducing a carbon dioxide-containing feedstream to an electrochemical cell, the carbon dioxide-containing feedstream comprising less than about 1000 ppm of carbon dioxide and the electrochemical cell comprising a cathode, an electrolyte membrane adjacent to the cathode, and an anode adjacent to the electrolyte membrane;
reacting the carbon dioxide of the carbon dioxide-containing feedstream at the cathode to produce carbonate ions;
transporting the carbonate ions through the electrolyte membrane and to the anode;
reacting the carbonate ions at the anode to produce carbon dioxide; and
recovering the carbon dioxide as a concentrated carbon dioxide feedstream.

13. The method of claim 12, wherein reacting the carbon dioxide of the carbon dioxide-containing feedstream at the cathode to produce carbonate ions comprises reacting the carbon dioxide at a temperature of from about 400° C. to about 650° C.

14. The method of claim 12, wherein reacting the carbon dioxide of the carbon dioxide-containing feedstream at the cathode comprises conducting the reaction using a chemical gradient of carbon dioxide.

15. The method of claim 12, wherein reacting the carbon dioxide of the carbon dioxide-containing feedstream at the cathode comprises applying an electrochemical potential between the cathode and the anode.

16. The method of claim 15, wherein applying an electrochemical potential between the cathode and the anode comprises applying a voltage of from about 0.7 V to about 1.0 V between the cathode and the anode.

17. The method of claim 12, further comprising producing a carbon dioxide-depleted stream at the anode.

18. The method of claim 17, wherein producing a carbon dioxide-depleted stream comprises producing oxygen at the anode.

19. The method of claim 12, wherein introducing a carbon dioxide-containing feedstream to an electrochemical cell comprises introducing the carbon dioxide-containing feedstream comprising less than about 1000 parts per million (ppm) of carbon dioxide to the electrochemical cell.

20. The method of claim 12, wherein introducing a carbon dioxide-containing feedstream to an electrochemical cell comprises introducing the carbon dioxide-containing feedstream comprising from about 350 ppm to about 500 ppm carbon dioxide to the electrochemical cell.
